(19) United States
(12) Patent Application Publication
(10) Pub. No.: US 2016/0137226 A1
(43) Pub. Date: May 19, 2016

(54) BODY CENTER MODULE

(71) Applicant: BASF SE, Ludwigshafen (DE)

(72) Inventors: Uwe WOLF, Stamberg (DE); Jan Kurt Walter SANDLER, Heidelberg (DE); Alex HORISBERGER, Ludwigshafen (DE); Tobias NACHTIGAELLER, Heidelberg (DE)

(73) Assignee: BASF SE, Ludwigshafen (DE)

(21) Appl. No.: 14/899,710

(22) PCT Filed: Jun. 16, 2014
(86) PCT No.: PCT/EP14/62507

§ 371 Date: Dec. 18, 2015

(30) Foreign Application Priority Data
Jun. 18, 2013 (EP) 13172427.0

(51) Int. Cl. B62D 21/02; B60N 2/015; B62D 29/04

(52) U.S. Cl. CPC B62D 21/02; B62D 29/04; B60N 2/015

(57) ABSTRACT

A body center module, including a floor panel including two depressions, which extend parallel to the longitudinal axis of the body center module, for receiving a driver's seat and a passenger seat, and an elevation which extends between the depressions. From the elevation between the depressions, two supports extend upward in a V-shape, and each support terminates in a roof beam which extends parallel to the longitudinal axis of the body center module.

The invention relates to a body center module, comprising a floor panel and supports which are connected to the floor panel and in each case terminate in a roof beam.

A vehicle body typically comprises a front module in which, for example, the motor of the motor vehicle is accommodated, a center module, having the passenger seats, and a rear module being the trunk in the case of, for example, a sedan, or the cargo area in the case of a station wagon.

Vehicle bodies are typically made of steel, wherein the vehicle body has a supporting floor structure which is produced as a floor panel in the region of the body center module. At a later stage, the seats for the driver and the passenger and, if applicable, a rear bench are mounted on the floor panel. In the case of present-day motor vehicles, the side modules of the motor vehicle, for example fenders, A-, B- and C-pillars, are attached laterally on the support structure. The A-, B- and C-pillars are connected to one another by cross beams and support the vehicle roof. Furthermore, roof beams are typically situated in each case between the A- and B-pillars and, furthermore, between the B- and C-pillars. The individual components of the vehicle body are typically welded to one another and, in order to obtain adequate resistance to corrosion, have to be subsequently provided with a coating in a complex process. In addition, cavities need to be sealed so that no water and, in particular, no salt, which facilitates corrosion, can enter.

In order to save energy for moving the motor vehicle, endeavors aimed at reducing the weight of the vehicle are presently being undertaken. This is possible, for example, by using materials having a lower density than steel, for example plastics. In particular non-structural components are presently already made from plastics. It is a further disadvantage of the present structure of motor-vehicle bodies that large amounts of material, which likewise lead to a higher weight, are required for achieving adequate stability.

It is, therefore, an object of the present invention to provide a body center module which is configured such that, on account of savings in materials and of the choice of materials, a lower weight than in conventional body center modules can be achieved.

The object is achieved by a body center module, comprising a floor panel having two depressions, which extend in the direction of travel, for receiving a driver's seat and a passenger seat, and an elevation which extends between the depressions, wherein two supports extend upward in a V-shape from the elevation between the depressions and each support terminates in a roof beam which extends parallel to the longitudinal axis of the body center module.

On account of the design having the upwardly extending supports in a V-shape it is possible to dispense with the structural A-, B-, C-pillars and the beams connecting the pillars which are typically employed in vehicles. On account of this, material can be saved on the one hand, and a simpler construction of the body center module can be achieved on the other hand. A further advantage is that, on account of the design, alternative materials, for example polymer materials, can also be used for the manufacture of the body center module and that a further weight reduction can be achieved in this manner.

On account of the configuration of the floor panel with two depressions, which extend parallel to the longitudinal axis of the body center module, and an elevation, which extends between the depressions, torsional stiffness of the floor panel is increased, as compared with a flat panel.

The longitudinal axis of the body center module extends from the front to the rear of the body center module and thus also from the front to the rear of the finished body after assembly with the remaining modules. In the finished vehicle, this corresponds to the orientation which extends in the direction of travel.

In one embodiment of the invention, a support post extends between each support and the floor panel. On account of the additional support post a further increase of strength is achieved. Furthermore, a cross beam may be situated between the support and the support post. Then, the structure consisting of support, support post and cross beam has an A-shape, wherein the legs of the A are connected to the elevations of the floor panel.

For a further increase of strength it is furthermore advantageous for the upwardly extending supports to be likewise connected to one another by a cross beam, such that the upwardly extending supports are configured in the shape of an “A” standing on its head. The tip of the “A” here is formed by that elevation of the floor panel with which the upwardly extending supports are connected. Stability is further increased when the upwardly extending supports, on their side which faces the floor panel, in each case fork out to form members which extend parallel to the longitudinal axis of the body center module, wherein the members are in each case connected to the elevation in the center between the depressions of the floor panel. It is furthermore advantageous for the upwardly extending supports to terminate, on their side which faces away from the floor panel, in a forking, wherein the roof beam is connected to the ends of the forking, such that torsional stiffness is likewise increased on account thereof.

Alternatively to the design of the supports which extend upward in the shape of an “A” standing on its head, it is also possible to execute the supports in the shape of, for example, a “T” or an “H”, wherein, also in this case, the upwardly extending supports may have an inclination in relation to the vertical. This inclination may be executed toward the side and/or, when viewed in the direction of travel, toward the front or the rear. In the case of a design as a “T”, two supports may also form the stem, wherein said supports may also converge from top to bottom or from bottom to top, such that an acute angle is configured between the supports either on that side which faces the roof or on that side which faces the floor.

The floor panel of the body center module can be designed as, for example, a sandwich construction. To this end it is possible, for example, to configure the floor panel with two panels made of fiber-reinforced plastic or metal, foam being introduced between the two panels made of fiber-reinforced plastic or metal. Alternatively, it is also possible to construct the floor panel from one piece and to design it using, for example, fiber-reinforced plastic or metal, preferably with local reinforcing ribs. The local reinforcing ribs serve for increasing torsional stiffness of the floor panel.

Preferably, rocker sills, which, for example, may be of a hollow clam-shell design and be produced from fiber-reinforced plastic or metal, are integrated in the floor panel. Alternatively, it is also possible to design the rocker sills as fiber-reinforced plastic or metal clam shells having a foam core. It is additionally possible to provide the rocker sills with a local wire reinforcement in order to increase the stability of the rocker sills.

The upwardly extending supports, support posts and cross beams may also have a sandwich construction and be formed from panels which are formed from fiber-reinforced plastic or metal and between which panels a foam has been introduced. Alternatively, it is also possible to design the supports, support posts and cross beams as hollow bodies made of fiber-reinforced plastic or metal and to fill them with a foam. Furthermore, it is also possible to design the supports, support posts and cross beams as a single shell made of fiber-reinforced plastic or metal, having local reinforcing ribs. Additionally, the design as a clam-shell hollow profile made of a plastic or metal is also possible.

In one embodiment of the invention, a seat back of a seat is in each case fastened on one support and one support post. On account of the fastening of the seat back of the seat on the support and support post an increase of stability is likewise achieved.

It is furthermore advantageous for each depression in the floor panel to be spanned by a seat shell. The seat shell here is preferably fastened in each case on the central elevation and on an outer elevation which delimits the depression and which typically forms the rocker sill. The fastening of the seat shell on the outer elevation and on the central elevation likewise additionally serves for increasing stability. The seat shell here serves for receiving the seat face and additionally has the advantage that, in the case of a side impact, reinforcement is achieved on account thereof.

If the body center module is to be used in the construction of an electrically-operated motor vehicle it is particularly advantageous for the space in the depression, which is to be spanned by the seat shell, to be used as construction space for a battery. To this end, a battery element is preferably accommodated in the depression under the seat shell. The position of the battery element in the depression in the floor panel serves for protecting the battery. Utilization of the depression under the seats as construction space for a battery allows the vehicle to be equipped with battery elements depending on the range requirement. In this manner, few battery elements may be provided in the case of a low range requirement, on account of which the construction space into which no battery elements have been inserted can be used as additional storage space. Additionally, on account of the reduction in the number of battery elements, the weight of the vehicle and thus also its energy requirement are reduced.

The construction of the seat shell preferably corresponds to the construction of the floor panel or of the supports, support posts and cross beams, for example in the form of a sandwich construction, as a single-shell construction or as a clam-shell hollow profile.

If a fiber-reinforced plastic is used in the manufacture of the floor panel, the supports, the support post, the cross beams and of the seat shell, a thermoplastics-based fiber-reinforced plastic is particularly preferably employed as matrix material. The fibers which are employed may be short fibers, long fibers or continuous fibers. If the fibers in the form of continuous fibers are employed, it is possible to employ those as laid fabrics, knitted fabrics, woven fabrics or in a non-oriented form. If the continuous fibers are employed as laid fabrics, woven fabrics or knitted fabrics it is possible for a plurality of layers of fibers to be positioned on top of one another. In the case of fiber-laid fabrics, the fibers of the individual layers may be twisted in relation to one another.

The fibers are particularly preferably employed in the form of laid fabrics.

Materials which are suited as fibers are, for example, glass fibers, carbon fibers, potassium titanate fibers, aramid fibers or basalt fibers. Polymer materials which are particularly suitable for the matrix are polyamide (PA), polyurethane (PU), polypropylene (PP), polybutylene terephthalate (PBT) or epoxy resins. Polyamide, polyurethane and epoxy resins are particularly preferable.

Additional reinforcement can be achieved in that a wire mesh is introduced into the individual components, in particular the floor panel, the supports, the support posts and the cross beams. The wire of the wire mesh here is preferably made of a metal.

Metals which are suitable for the wire are, for example, steel, aluminum or magnesium. Steel is particularly preferable as a metal for the wire.

If metals are used for the manufacture of the floor panel, the supports, the support posts or the cross beams, in particular for the clam-shell construction having foam introduced in between or for the single-shell construction, the metal is preferably selected from steel, aluminum or magnesium.

The foam which is introduced between the two shells of fiber-reinforced plastic or metal in the case of a clam-shell construction is preferably a polymer foam. Suitable polymer foams are, for example, closed-cell or open-cell foams on the basis of polyurethane (PU), polyether sulfone (PES), polyamide (PA), polybutylene terephthalate (PBT) or polyester.

The connections between the floor panel, the supports, the support posts and the cross beams is preferably form-fitting. The floor panel and the supports, the support posts and the cross beams are particularly preferably welded to one another at the corresponding connection points. Apart from welded connections, it is also possible, in an alternative manner, to adhesively bond, to rivet or to screw the individual parts to one another.

Particularly in the case where the supports, support posts and cross beams are designed as hollow profiles, it is alternatively also possible for plastic parts to be inserted into the hollow profiles and to be screwed or adhesively bonded to them.

For the purpose of manufacturing a complete vehicle, the body center module is connected to a front module and a rear module. The body center module here is designed such that the front module, or the rear module, respectively, can be connected to the body center module in a form-fitting manner, for example by welding or adhesive bonding, or in that a force-fitting connection takes place, for example by screwing.

In the case where components are connected to one another in a form-fitting manner, they are preferably adhesively bonded to one another.

Exemplary embodiments of the invention are illustrated in the figures and are described in more detail in the following description.

In the drawings:

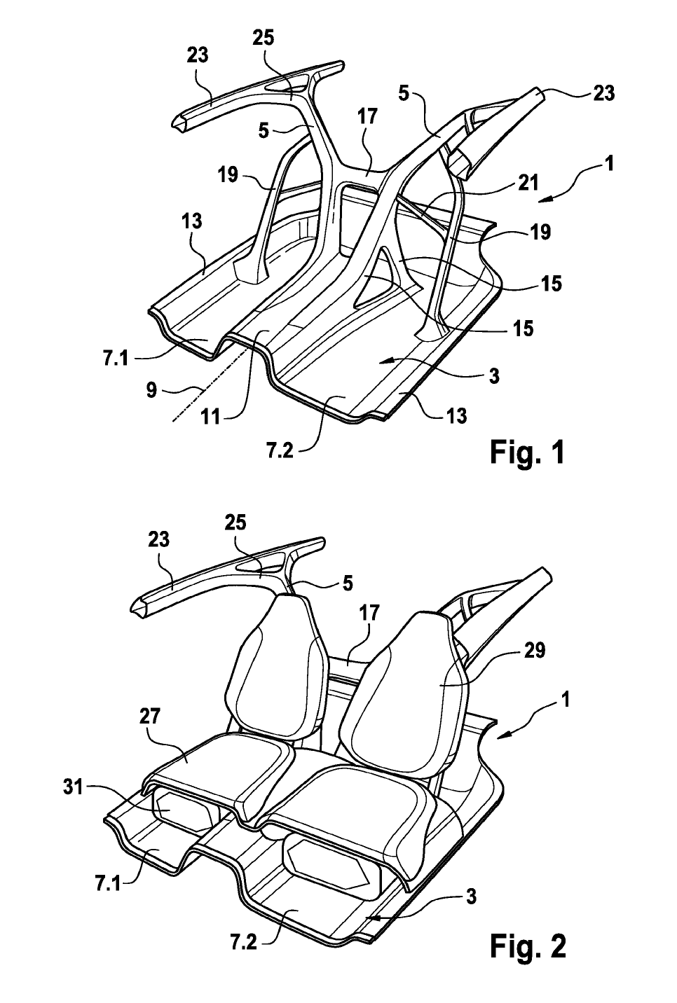

FIG. 1 shows a three-dimensional illustration of a body center module,

FIG. 2 shows a three-dimensional illustration of a body center module having installed seat shells.

In FIG. 1 a body center module is shown in a three-dimensional illustration.

A body center module 1 comprises a floor panel 3 and supports 5. The floor panel 3 has two depressions 7.1, 7.2 which extend parallel to the longitudinal axis 9 of the body center module 1. An elevation 11 is situated between the depressions 7.1, 7.2. The elevation 11 is designed in the form of a vehicle tunnel, such that, for example, a drive train for the motor vehicle can be mounted therebelow. On the respective outer sides, the depressions 7.1, 7.2 are delimited by an outer elevation 13, which, for example, forms a rocker sill.

According to the invention, the two supports 5 extend upward in a V-shape from the elevation 11. V-shape means that the supports 5 in each case extend upward and outward from the center of the body center module, wherein the supports 5, as illustrated in FIG. 1, may have a bend.

In order to increase stability, it is advantageous for the supports 5, on the side which faces the floor panel 3, to fork out to form two members 15. The members here are oriented parallel to the longitudinal axis 9 of the body center module 1. The respective support 5 is fastened with the members 15 on the elevation 11 of the floor panel 3. On account of forking out to form two members 15, the torsional stiffness in the direction of the longitudinal axis 9 of the body center module 1 is increased.

It is furthermore advantageous for the supports 5 to be connected to one another with a cross beam 17, as in the embodiment illustrated here. On account of the cross beam 17, torsional stiffness in the transverse direction to the longitudinal axis 9 of the body center module 1 is increased. An additional increase of torsional stiffness can be achieved by means of support posts 19 which extend between the support 5 and the floor panel 3. The support posts 19 here are preferably connected to the floor panel 3 in the region of the outer elevation 13. An additional increase of strength can be achieved when the support posts 19 are additionally connected to one another with a cross member 21 which extends between the support post 19 and the support 5. Here, the support 5, the support post 19 and the cross member 21 preferably form the shape of a large A. Furthermore, the supports 5 and the cross beam 17, which extends between the supports 5, form the shape of a large A lying on its tip.

The supports 5, at their end which faces away from the floor panel 3, preferably terminate in a roof beam 23. The length of the roof beam 23 here preferably corresponds to the length of the body center module 1. In order to increase torsional stiffness of the connection of the support 5 and the roof beam 23, it is preferable for the support 5 to terminate in each case in a forking 25 and for the roof beam 23 to be fastened on the forking 25. On account thereof, two fastening points are obtained on the roof beam 23, such that the latter has increased torsional stiffness.

The roof beams 23 are preferably designed such that a cover panel for the vehicle body can be received between the roof beams 23, wherein the cover panel, which is not illustrated here, is connected in each case on one side with a roof beam 23. The roof beams 23 are furthermore preferably designed such that the side walls of the vehicle can likewise be fastened on the roof beam 23.

Materials which are suitable for the floor panel 3, the supports 5, the cross beam 17, the support posts 19, the cross members 21 and the roof beams 23 are, for example, metals or polymers, preferably reinforced polymers, in particular fiber-reinforced polymers. Metals which may be employed are, for example, steel, aluminum or magnesium. However, the use of polymers is preferable, since they have a lower density than metals and the mass of the body center module 1 can thus be further lowered by using polymers. When polymers are employed as a material, both thermoplastic and also duroplastic thermoplastics may be employed. Preferably thermoplastic polymers, which are fiber reinforced, are used. As already described earlier, the fibers may be employed as short fibers, long fibers or continuous fibers.

Apart from a solid construction or a construction in the form of a hollow body made from only one material it is also possible to design the individual components, namely the floor panel 3, the support 5, the cross beam 17, the member 15, the support post 19, the cross member 21 and the roof beams 23 in a sandwich construction, wherein the latter has two shells made of a plastic, in particular of a fiber-reinforced plastic, or a metal, between which shells a polymer foam is introduced. A construction of this type having multiple shells has the advantage that, on account of the introduced foam, insulation, both thermal insulation as well as sound insulation, can be simultaneously implemented.

In FIG. 2, the body center module having installed seats is illustrated.

In one embodiment of the invention, the seats are fixedly connected to the body center module 1. To this end it is possible to fasten a seat shell 27 over the depressions 7.1, 7.2. To this end, the seat shell 27 is preferably fastened in each case on the outer elevations 13 and on the central elevation 11. Depending on the material of the seat shell 27 and of the floor panel 3, the connection may take place in a form-fitting or force-fitting manner. In this manner, it is possible, for example, to weld or adhesively bond the seat shell 27 to the floor panel 3. Alternatively, riveting or screwing is also possible. The seat shell 27 may be ergonomically designed such that it can also be directly used as a seat. Alternatively, it is also possible for the seat shell 27 to be designed such that additional seats are mounted onto the seat shell 27, wherein the seats, for example, may be adapted to the ergonomics of the passenger sitting on the respective seat.

It is furthermore advantageous for the seat-back modules 29 to be directly connected to the support 5. On account of the connection of the seat back 29 to the support 5 and preferably the support post 19 and the cross member 21, an additional increase in torsional stiffness can be achieved. Adapting the seating position to the respective driver or passenger can be achieved, for example, in that individually adapted seat-back modules are attached to the seat back 29. Alternatively, however, it would also be possible, for example, to mount a mounting of the seat back 29 on the support 5, wherein the mounting is designed such that it enables an adjustment of the seat back 29.

If the body center module is to be used in a motor vehicle which is electrically operated or equipped with a hybrid drive having an electrical component, it is furthermore advantageous for the space under the seat shell 27 in the depressions 7.1 and 7.2 to be used for the installation of battery elements 31. An enlargement of the construction space can be achieved in that, for example, as in the embodiment illustrated here, the seat shell 27 has an elevation in the region of the respective seat and comprises downwardly projecting sides with which the seat shell 27 is fastened to the floor panel 3. On account of the positioning of the battery elements 31 under the seat shell 27 in the depressions 7.1, 7.2, in particular protection against damage in the event of a rear-end collision is achieved. In addition, no additional storage space, which could be used, for example, as luggage space, is required for the batteries. It is furthermore also possible to equip the vehicle with battery elements on an individual basis, depending on the range requirement.

### LIST OF REFERENCE SIGNS

1 Body center module
3 Floor panel
5 Support
7.1 Depression
7.2 Depression
9 Longitudinal axis
11 Elevation
13 Outer elevation
15 Member
17 Cross beam
19 Support post
21 Cross member
23 Roof beam
25 Forking
27 Seat shell
29 Seat back
31 Battery element

1-9. (canceled)

10. A body center module, comprising:
a floor panel including two depressions, which extend parallel to the longitudinal axis of the body center module, for receiving a driver's seat and a passenger seat; and
an elevation which extends between the depressions, wherein two supports extend upward in a V-shape from the elevation between the depressions and each support terminates in a roof beam which extends parallel to the longitudinal axis of the body center module.

11. The body center module according to claim 10, wherein a support post extends between each of the supports and the floor panel.

12. The body center module according to claim 10, wherein the upwardly extending supports are connected to one another by a cross beam.

13. The body center module according to claim 10, wherein a seat back of a seat is in each case fastened on one support.

14. The body center module according to claim 10, wherein each depression is spanned by a seat shell, wherein the seat shell is fastened on the central elevation and on an outer elevation which delimits the depression.

15. The body center module according to claim 14, wherein a battery element is accommodated in the depression under the seat shell.

16. The body center module according to claim 15, wherein the floor panel, the upwardly extending supports, the support posts, and the cross beams are produced from a reinforced polymer material.

17. The body center module according to claim 16, wherein the central elevation and/or the outer elevations which laterally delimit the depressions are reinforced with a wire mesh.

18. The body center module according to claim 16, wherein the polymer material is selected from polyurethane, polyamide, polybutylene terephthalate, polypropylene, and epoxy resin.
